(19) United States
(12) Patent Application Publication
(10) Pub. No.: US 2014/0377441 A1
(43) Pub. Date: Dec. 25, 2014

(54) Clear Protein Beverage

(71) Applicant: Kevin N. Stratton, Oakville (CA)

(72) Inventor: Kevin N. Stratton, Oakville (CA)

(21) Appl. No.: 13/923,707

(22) Filed: Jun. 21, 2013

(51) Int. Cl. A23L 2/66

(52) U.S. Cl. CPC A23L 2/66
USPC 426/590

(57) ABSTRACT

A non-carbonated beverage composition comprising a source of protein in an amount up to about 30% weight (wt %) of the composition and a source of edible acid in an amount up to about 1.2 wt % of the composition.

### FIELD OF THE INVENTION

This invention relates generally to beverage compositions and particularly to palatable clear non carbonated beverage compositions containing proteins, fiber and antioxidants.

### BACKGROUND

Protein rich products, particularly those containing whey protein are highly sought after, and several different kinds of product have been developed. Given the advantages of whey protein, it has become a popular source of nutrition in the form of whey protein supplemented candy bars and in whey protein powders. However there is a marked absence of whey protein based beverages.

One of the obstacles to be overcome is production of a clear protein based beverage without incurring separation out or precipitation of the protein from the liquid during manufacture and handling, shipping and storage. In addition to manufacturability and shelf life, the taste of the beverage may be affected by the kind of proteins present, which may be particularly exacerbated in combination with carbonation. The interaction of the ingredients, particularly the protein with the minerals and other ingredients, often cause the protein to precipitate and frequently cause the entire composition to become very viscous and cloudy or to gel or foam. Similarly, these interactions may change the physical or chemical properties of the composition in a way that adversely affects the taste, color, odor, mouth-feel and other physical properties of the composition. Methods for overcoming the problems caused by interactions between proteins, and other constituents in food compositions are known in the art. Most involve the use of additives or stabilizers to disrupt the interactions between the ingredients and keep the protein and other ingredients in solution during processing and storage.

Whey proteins are commonly used as the source of protein in food supplements. However whey proteins are known to be astringent at low pH. Astringency is defined as the tactile sensation, mainly on the tongue, caused by astringent compounds when in contact with human saliva. This astringency has also been one of the barriers to creating palatable protein based clear beverage.

A further obstacle to creating protein based beverage is that beverages are more likely to be susceptible to biologically active microbes, causing clouding, spoiling and reduced shelf life. While treatment techniques such as heat treatment are available to inactivate microbes, conventional heat treatment techniques expose the proteins to denaturing and thus reducing their nutritional attributes. Furthermore various chemical preservatives may be used; however these are undesirable due to their potential negative health effects.

### SUMMARY

The present method provides for production of a beverage composition by careful selection of ingredients and controlling their amounts, the clarity, viscosity, pH, color, texture, taste, aftertaste, mouth-feel, stability, and other physical properties of the composition to produce a palatable protein based beverage composition with an extended shelf-life.

According to an embodiment of the present matter there is provided a beverage composition comprising: a source of protein in an amount up to about 30% weight (wt %) of the composition; a source of edible acids in an amount up to about 1.2 wt % of the composition.

In one embodiment, of the composition the edible acid is selected from the group consisting of citric acid, phosphoric acid, combinations of citric acid and phosphoric acid, and combinations of malic acid with another edible acid selected from the group consisting of citric acid and phosphoric acid.

In a further aspect the beverage composition includes a source of fiber in an amount up to to about 18 wt % of the composition.

In a further aspect the beverage composition includes a source of antioxidants in an amount up to about 24 wt %.

In an embodiment the source of antioxidants is selected from the group consisting of organic green teas, white tea and blueberries.

In addition, the invention includes a process for producing a beverage, comprising: forming a protein slurry; forming an aqueous solution; mixing the protein slurry and aqueous solution; adding edible acids to the mixture of the protein slurry and aqueous solution in amounts sufficient to form up to about 30 wt % of the final composition; adjusting the pH, and temperature of the mixture; and pasteurizing the mixture.

In a further aspect the process the pH is adjusted to be less than 3.7

In a further aspect the process the pH is adjusted to be in a range of 3 to 3.5.

In a further aspect the beverage composition includes a sweetening agent.

In an embodiment the sweetening agent is selected from the group consisting cane sugar, fruit juice and a Steviol glycoside.

In a further aspect the fiber is inulin.

In a further aspect the protein is whey protein isolate that has been cold, cross-flow membrane extracted.

### DETAILED DESCRIPTION OF THE PREFERRED EMBODIMENTS

### Definitions

The term “weight percentages” and the acronym “wt %” as used herein refer to weight percentages based on the total weight of the beverage composition in its final form with all ingredients added, including the water.

The term “fiber” as used herein, unless indicated otherwise, refers to a single fiber or mixtures of fibers.

In the present description, the term “clear” beverage is used to mean a non cloudy, non frothy or non opaque mixture. On the other hand the beverage may contain a coloring corresponding to a particular flavor, however this is still considered a clear beverage.

Whey protein isolates useful in the invention can be obtained commercially from many sources well known in the art. Whey proteins are pure high quality proteins found in cow's milk. Whey proteins are most often produced in conjunction with the cheese making process. During this process approximately half of the milk solids go into the cheese (curds) and the other half remain with the liquid whey. Whey proteins as a component of a healthy diet provide a number of important health benefits. Whey proteins are known to enhance the body's immune system by raising the anti-oxidant (glutathione) levels and reducing the risk of infections by improving the immune system's ability to respond to infectious agents. Whey proteins are also known to have a potential positive effect in other areas such as appetite suppression, cholesterol reduction, and the inhibition of dental plaque and dental caries.

Whey protein may be obtained as a whey protein isolate or whey protein concentrate. Whey protein is available as whey protein concentrate, which may be selected to contain whey protein at a given concentration which may range from about 20% by weight to about 85% by weight protein. Whey protein isolate contains 90% by weight or more whey protein, and little, if any, fat cholesterol, or carbohydrates (e.g., lactose).

There is a difference in the characteristics of whey protein isolate that has been heat and/or acid extracted and whey protein isolate that has been cold, cross-flow membrane extracted. Proteins may be damaged, or denatured by heating for a prolonged time to a high temperature—such as occurs during a heat-based extraction method. Likewise, when certain acids are used in the extraction process, they too can damage the milk proteins.

A protein beverage according to an embodiment of the present matter was prepared in the following general manner. The ingredients were added to a mixing container in the weight percentages as described herein. The pH and sweetness were tested. The beverage mixture was then bottled using appropriate bottling and pasteurization methods as may be known in the art.

The following examples are given as particular embodiments of the invention and to demonstrate the practice and advantages thereof. It is understood that the examples are given by way of illustration and are not intended to limit the specification or the claims to follow in any manner. In the following examples a base weight of 2000 grams of the composition was prepared. Each of the ingredients listed in the table below is admixed to form the composition.

### EXAMPLE 1

### Flavored Beverage

| | | Formula | |
|---|---|---|---|
| | | % by | mL Per |
| Ingredients | Base (g) | weight | 473 mL |
| Water | 2823.42 | 91.2% | 431.2 |
| Organic Green Tea | 20.07 | 1.0% | 4.75 |
| Liquid Extract | | | |
| Inulin | 30.84 | 1.5% | 7.3 |
| Sweetener | 53.89 | 2.7% | 12.7 |
| Flavoring | 12.03 | 0.6% | 2.85 |
| Whey Protein | 50.20 | 2.5% | 11.87 |
| Isolate | | | |
| Citric acid | 0.83 | 0.0% | 0.2 |
| Green Tea Flavor | 1.52 | 0.1% | 0.36 |
| Total | 2000.00 | 100.0% | 473 mL |

Steviol glycosides (Stevia extract) may be used as a sweetener and organic white tea may be used instead of or in combination with green tea as antioxidants.

The above described exemplary embodiments are not intended to limit the scope of the present invention, as one skilled in the art can, in view of the present disclosure may expand such embodiments to correspond with the subject matter of the invention claimed below.

1. A non-carbonated clear beverage composition comprising:
a source of protein in an amount up to about 30% weight (wt %) of the composition;
a source of edible acid in an amount up to about 1.2 wt % of the composition; and
a source of fiber in an amount to about 18 wt of the composition wherein the pH of the composition is adjusted to be in a range greater than 3.5 and less than or equal to 3.7.

2. (canceled)

3. The composition of claim 1, further including a source of antioxidants in an amount up to 24 wt %.

4. (canceled)

5. The composition of claim 1, further including a source of antioxidants in an amount up to 24 wt %.

6. The composition of claim 1, further including a sweetening agent.

7. The composition of claim 6, wherein the sweetening agent is selected from the group consisting of cane sugar, fruit juice and a Steviol glycoside.

8. The composition of claim 1, wherein the edible acid is selected from the group consisting of citric acid, phosphoric, acid, combinations of citric acid and phosphoric acid, and combinations of malic acid with another edible acid selected from the group consisting of citric acid and phosphoric acid.

9. The composition of claim 1 wherein the source of protein is a whey protein.

10. The composition of claim 9, wherein the whey protein isolate is cold, cross-flow membrane extracted.

11. The composition of claim 1, wherein the source of fiber is a soluble dietary fiber.

12. The composition of claim 11, wherein the dietary fiber is inulin.
